(19) United States
(12) Patent Application Publication
(10) Pub. No.: US 2024/0187530 A1
(43) Pub. Date: Jun. 6, 2024

(54) CONTROL OF START AND STOP OF PAUSE OF CHARGING IN A WIRELESS NETWORK

(71) Applicant: Telefonaktiebolaget LM Ericsson (publ), Stockholm (SE)

(72) Inventors: Yong YANG, Kållered (SE); Erik WIKSTRÖM, Göteborg (SE)

(21) Appl. No.: 18/553,811

(22) PCT Filed: Apr. 6, 2022
(86) PCT No.: PCT/IB2022/053235

§ 371 Date: Oct. 3, 2023

Related U.S. Application Data
(60) Provisional application No. 63/171,138, filed on Apr. 6, 2021.

(51) Int. Cl. H04M 15/00; H04W 4/24

(52) U.S. Cl. CPC H04M 15/39; H04M 15/60; H04W 4/24

(57) ABSTRACT

A method, system and apparatus are disclosed. According to one or more embodiments, a control plane node is provided. The control plane node includes processing circuitry configured to: determine to one of pause and resume a usage measurement; and cause transmission, to a user plane node, of a request indicating to one of pause and resume the usage measurement for a plurality of Usage Reporting Rules, URRs, based on the determination.

### FIELD

The present disclosure relates to wireless communications, and in particular, to activating or deactivating pause of charging using at least one indication at the message level of packet forwarding control protocol (PCFP) level.

### BACKGROUND

At the Third Generation Partnership Project (3GPP) Technical Specification Group (TSG) CT WG4 (CT4) meeting, 3GPP agreed to the following Work Item related to seeking a user plane based solution for activating packet data network gateway (PGW)/session management function (SMF) Pause of Charging.

### C4-211522 Start of Pause of Charging via User Plane

One motivation of this Work includes that:

When control and user plane separation (CUPS) is deployed in the network, as specified in some 3GPP standards such as in, for example, 3GPP Technical Specification (TS) 29.244, when the user plane (UP) Function (serving gateway-U (SGW-U) or I/V-user plane function (UPF)) detects the dropped Downlink (DL) Traffic Threshold is reached, the UP function sends a report to the control plane (CP) function (i.e., SGW-C or I/V-session management function (SMF)) which leads the CP function to send a “Start of Pause of Charging” request via control plane signalling to the peer CP function (PGW-C, or (h)SMF) and in turn the peer CP function then sends an Sxb/N4 message to instruct the peer UP function (PGW-U, PDU session anchor user plane function (PSA UPF) to pause charging measurements.

Such a start of pause of charging takes time, i.e., transferring time of 2 packet forwarding control protocol (PFCP) messages plus transferring time between CP functions plus additional processing time (to handle PFCP, or general packet radio service (GPRS) tunnelling protocol (GTPv2) for evolved packet system (EPS) or hypertext transfer protocol (HTTP) message for 5G core network (5GC)), more DL data packets will be charged in the PGW-U or PDU session anchor (PSA) UPF while the packets are discarded in the SGW-U and I/V-UPF. With the very high throughputs that are supported in EPS and 5GS today, this can still result in significant charging discrepancies, especially considering enhanced mobile broadband (eMBB) services.

A solution is desired to speed up the triggering of charging pause in the PGW-U or PSA UPF.

3GPP has agreed the following relevant CRs for this Work Item:
C4-211620 Reserve IE types for GTP-U
C4-211621 Tunnel Status notifying Pause of Charging
C4-211708 Enhancement on the support of Pause of Charging

There is a 3GPP editor's note left for further study:
The PGW-C/SMF will know that charging is to be paused typically after the PGW-U/PSA. It is for further study (FFS) how to ensure that the PGW-C/SMF does not re-activate unintentionally charging in the PGW-U/PSA if it needs to send a modified Measurement Information IE to the UP function after charging is paused in UP function via user plane (UP) but before PGW-C/SMF receives the request from SGW-C or V/I-UPF to pause charging.

### This Issue May Need to be Resolved

The existing mechanism to enable control plane (CP) function to start or stop pause of charging is described in 3GPP standards such as in, for example, clause 5.2.2.2.1 of 3GPP TS 29.244, as described below:
The CP function may request at any time for the UP function to activate or deactivate a network resources usage measurement, using the Inactive Measurement flag of the Measurement Information IE (i.e., information element) of the URR.
This can be used in a PGW-U for the PGW Pause of Charging procedure (as described in 3GPP standards such as in, for example, 3GPP TS 23.401).
When the Notifying Start of Pause of Charging (NSPOC) feature as specified in 3GPP standards such as in, for example, clause 5.30 of 3GPP standards such as, for example, 3GPP TS 29.244 is supported by the CP and UP function, the CP function may provision:
Measurement Information with the “Send Start Pause of Charging” Flag set to “1”, to request the UP function (SGW-U or I/V-UPF) to send a Start Pause of Charging indication to the upstream GTP-U entity(s) when the Dropped DL Traffic Threshold is reached.
Measurement Information with the “Applicable for Start of Pause of Charging” Flag set to “1”, to indicate the UP function to stop the usage measurement for the usage reporting rule (URR) when receiving Start Pause of Charging indication from the peer downstream GTP-U entity.
When the NSPOC feature is supported by the CP and UP function, the CP function may use the “SUMPC” (Stop of Usage Measurement to Pause Charging) and “RUMOC” (Resume of Usage Measurement to Un-pause of Charging) flags in the PFCPSMReq-Flags IE to request UP function stop or resume the usage measurement. As described in 3GPP standards such as in, for example, clause 5.30 of 3GPP standards such as, for example, 3GPP TS 29.244.
The CP function may request the UP function to measure network resources usage and generate the corresponding Usage Reports only for a number of times, by provisioning the “Number of Reports” IE in a URR, if the UP function supports the NORP (Number of RePorts) feature (as described in 3GPP standards such as in, for example, clause 8.2.25-1 of 3GPP standards such as, for example, 3GPP TS 29.244). If so, the URR becomes inactive in the UP function after the requested “Number of Reports” have been reported.
The CP function may resume the measurement for an inactive URR by setting the Inactive Measurement flag of the Measurement Information IE of the URR to “0” in the Update URR IE in a PFCP Session Modification Request message, with or without the Number of Report IE. If the CP function wishes the UP function to perform continuous measurement for a URR which was provisioned with a Number of Reports (i.e., to no longer limit the number of reports to be generated), the CP function provides the Number of Reports IE in the Update URR with a null length to delete the limit on the number of reports to be generated.
The Number of Reports can be provisioned in a URR regardless of which measurement method is used.

A possible solution (to solve the issue as described above and in the 3GPP editor's note as in clause 2.1 of, for example, 3GPP TS 29.244) is to introduce new control information to resume the usage measurement, i.e., to avoid using the existing Inactive Measurement Flag.

The existing mechanism to deactivate/inactivate or re-activate usage measurement is that the CP function includes an Update URR IE with the Inactive Measurement Flag set for inactivate or re-activate respectively, for EACH OF URRs which are applicable for charging. That is, the inactivate/re-activate occurs at the usage report level and/or per URR.

With introducing the NSPOC feature, where a new flag “ASPOC” or “Applicable for Start of Pause of Charging” bit is introduced to be included in the Measurement Information when provisioning a URR; when it is set to “1”, it indicates to the UP function that the URR is intended for charging, therefore the URR is applicable for starting of pause of charging as well as resuming the charging, i.e., usage measurement, and this is true regardless if such start of pause of charging is requested by the CP function, e.g., PGW-C or (H-)SMF; or requested by the downstream GTP-U entity via sending a GTP-U Tunnel Status message with the Start Pause of Charging indication is set to “1”. Hence, the pausing/resuming of charging described above occurs per URR, which may limit configurability and/or speed at which pausing/resuming of charging can occur.

### SUMMARY

Some embodiments advantageously provide methods, systems, and apparatuses for activating or deactivating pause of charging using at least one indication at the message level of PCFP level. In some embodiments, “activating or deactivating pause of charging” is performed by pause/resume of usage measurements that is configured to pause/resume charging.

One or more embodiments described herein provide a protocol mechanism, to be used in EPC and 5GC, when both the CP function (PGW-C or (H-)SMF) and the UP function (PGW-U or PSA UPF) support the NSPOC feature. The NSPOC feature may related to a NSPOC flag/bit that the UP function uses to indicate support for the functionality described herein. The UP may indicate this support to the CP function during the PFCP association setup by including the UP Function Features IE with the NSPOC flag/bit set. The CP function (PGW-C, or (H-)SMF) provides two new and different flags to control UP function to start Pause of Charging (i.e., stop usage measurement) or stop Pause of charging (i.e., resume the usage measurement) respectively, and those flags are provided at PFCP session message level and for all Usage Report Rules provisioned for the PFCP session, and if these Usage Reporting Rules are intended for charging the ASPOC flag is set.

The two new flags may be referred to as described below where the semantics of the flags are also described:
set the “SUMPC” flag in PFCPSMReq-Flags IE to “1” to request UP function to stop the usage measurement for all URRs with “ASPOC” flag is set to “1”, e.g., when the CP function is informed to start Pause of Charging via control plane;
set the “RUMPC” flag in PFCPSMReq-Flags IE to “1” to request UP function to resume the usage measurement for all URRs with “ASPOC” flag is set to “1”, e.g. when the CP function is informed to stop Pause of Charging via control plane.

According to one aspect of the present disclosure, a control plane node is provided. The control plane node includes processing circuitry configured to: determine to one of pause and resume a usage measurement; and cause transmission, to a user plane node, of a request indicating to one of pause and resume the usage measurement for a plurality of Usage Reporting Rules, URRs, based on the determination.

According to one or more embodiments of this aspect, the indication to pause the usage measurement for the plurality of URRs, for which value of an Applicable for Start of Pause of Charging, ASPOC, flag is set to a “1” bit value, is provided by a first flag set to a predefined bit value. According to one or more embodiments of this aspect, the predefined bit value for the first flag is a “1” bit value. According to one or more embodiments of this aspect, the first flag is a Stop of Usage Measurement to Pause Charging, SUMPC, flag.

According to one or more embodiments of this aspect, the indication to resume the usage measurement for the plurality of URRs, for which value of an Applicable for Start of Pause of Charging, ASPOC, flag is set to a “1” bit value, is provided by a second flag set to a predefined bit value. According to one or more embodiments of this aspect, the predefined bit value for the second flag is a “1” bit value. According to one or more embodiments of this aspect, the second flag is a Resume of Usage Measurement to Un-pause of Charging, RUMPC, flag. According to one or more embodiments of this aspect, the indication is on a message level in the request.

According to one or more embodiments of this aspect, the control plane node is a Session Management Function, SMF, node or Packet Gateway Control function, PGW-C, node. According to one or more embodiments of this aspect, the control plane node provides a session management functions. According to one or more embodiments of this aspect, the user plane node is a User Plane Function, UPF, node or Packet Gateway User function, PGW-U, node. According to one or more embodiments of this aspect, the request is one of a Packet Forwarding Control Protocol, PFCP, session establishment request and PFCP session modification request associated with a PFCP session, the PFCP session being associated with the plurality of URRs.

According to another aspect of the present disclosure, a method implemented by a control plane node is provided. A determination is performed to one of pause and resume a usage measurement. Transmission is caused, to a user plane node, of a request indicating to one of pause and resume the usage measurement for a plurality of Usage Reporting Rules, URRs, based on the determination.

According to one or more embodiments of this aspect, the indication to pause the usage measurement for the plurality of URRs, for which value of an Applicable for Start of Pause of Charging, ASPOC, flag is set to a “1” bit value, is provided by a first flag set to a predefined bit value. According to one or more embodiments of this aspect, the predefined bit value for the first flag is a “1” bit value. According to one or more embodiments of this aspect, the first flag is a SUMPC flag.

According to one or more embodiments of this aspect, the indication to resume the usage measurement for the plurality of URRs, for which value of an Applicable for Start of Pause of Charging, ASPOC, flag is set to a “1” bit value, is provided by a second flag set to a predefined bit value. According to one or more embodiments of this aspect, the predefined bit value for the second flag is a “1” bit value. According to one or more embodiments of this aspect, the second flag is a Resume of Usage Measurement to Un-pause of Charging, RUMPC, flag.

According to one or more embodiments of this aspect, the indication is on a message level in the request. According to one or more embodiments of this aspect, the control plane node is a Session Management Function, SMF, node or Packet Gateway Control function, PGW-C, node. According to one or more embodiments of this aspect, the control plane node provides a session management functions. According to one or more embodiments of this aspect, the user plane node is a User Plane Function, UPF, node or Packet Gateway User function, PGW-U, node. According to one or more embodiments of this aspect, the request is one of a Packet Forwarding Control Protocol, PFCP, session establishment request and PFCP session modification request associated with a PFCP session, the PFCP session being associated with the plurality of URRs.

According to another aspect of the present disclosure, a user plane node is provided. The user plane node includes processing circuitry configured to: receive, from a control plane node, a request indicating to one of pause and resume a usage measurement for a plurality of Usage Reporting Rules, URRs, and perform one of pausing and resuming of the usage measurement for the plurality of URRs based at least on the indication.

According to one or more embodiments of this aspect, the indication to pause the usage measurement for the plurality of URRs, for which value of an Applicable for Start of Pause of Charging, ASPOC, flag is set to a “1” bit value, is provided by a first flag set to a predefined bit value. According to one or more embodiments of this aspect, the predefined bit value for the first flag is a “1” bit value. According to one or more embodiments of this aspect, the first flag is a Stop of Usage Measurement to Pause Charging, SUMPC, flag.

According to one or more embodiments of this aspect, the indication to resume the usage measurement for the plurality of URRs, for which value of an Applicable for Start of Pause of Charging, ASPOC, flag is set to a “1” bit value, is provided by a second flag set to a predefined bit value. According to one or more embodiments of this aspect, the predefined bit value for the second flag is a “1” bit value. According to one or more embodiments of this aspect, the second flag is a Resume of Usage Measurement to Un-pause of Charging, RUMPC, flag.

According to one or more embodiments of this aspect, the indication is on a message level in the request. According to one or more embodiments of this aspect, the user plane node is a User Plane Function, UPF, node or Packet Gateway User function, PGW-U, node. According to one or more embodiments of this aspect, the control plane node is a Session Management Function, SMF, node or Packet Gateway Control function, PGW-C, node. According to one or more embodiments of this aspect, the request is one of a Packet Forwarding Control Protocol, PFCP, session establishment request and PFCP session modification request associated with a PFCP session where the PFCP session is associated with the plurality of URRs.

According to another aspect of the present disclosure, a method implemented by a user plane node is provided. A request indicating to one of pause and resume a usage measurement for a plurality of Usage Reporting Rules, URRs is received from a control plane node. One of pausing and resuming of the usage measurement for the plurality of URRs is performed based at least on the indication.

According to one or more embodiments of this aspect, the indication to pause the usage measurement for the plurality of URRs, for which value of an Applicable for Start of Pause of Charging. ASPOC, flag is set to a “1” bit value, is provided by a first flag set to a predefined bit value. According to one or more embodiments of this aspect, the predefined bit value for the first flag is a “1” bit value. According to one or more embodiments of this aspect, the first flag is a Stop of Usage Measurement to Pause Charging, SUMPC, flag.

According to one or more embodiments of this aspect, the indication to resume the usage measurement for the plurality of URRs, for which value of an Applicable for Start of Pause of Charging, ASPOC, flag is set to a “1” bit value, is provided by a second flag set to a predefined bit value. According to one or more embodiments of this aspect, the predefined bit value for the second flag is a “1” bit value. According to one or more embodiments of this aspect, the second flag is a Resume of Usage Measurement to Un-pause of Charging, RUMPC, flag.

According to one or more embodiments of this aspect, the indication is on a message level in the request. According to one or more embodiments of this aspect, the user plane node is a User Plane Function, UPF, node or Packet Gateway User function, PGW-U, node. According to one or more embodiments of this aspect, the control plane node is a Session Management Function, SMF, node or Packet Gateway Control function, PGW-C, node. According to one or more embodiments of this aspect, the request is one of a Packet Forwarding Control Protocol, PFCP, session establishment request and PFCP session modification request associated with a PFCP session, the PFCP session being associated with the plurality of URRs.

According to another aspect of the present disclosure, a control plane node is configured to perform the control plane node method described herein. According to another aspect of the present disclosure, a user plane node is configured to perform the user plane node method described herein.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a schematic diagram of an example network architecture illustrating a communication system connected via an intermediate network to a host computer according to the principles in the present disclosure;

FIGS. 2a and 2b are block diagrams of a portion of the system of FIG. 1;

FIG. 3 is a flowchart illustrating example methods implemented in a communication system for executing a client application at a wireless device according to some embodiments of the present disclosure;

FIG. 4 is a flowchart illustrating example methods implemented in a communication system for receiving user data at a wireless device according to some embodiments of the present disclosure;

FIG. 5 is a flowchart illustrating example methods implemented in a communication system for receiving user data from the wireless device at a host computer according to some embodiments of the present disclosure;

FIG. 6 is a flowchart illustrating example methods implemented in a communication system for receiving user data at a host computer according to some embodiments of the present disclosure;

FIG. 7 is a flowchart of an example process in a control plane node according to some embodiments of the present disclosure;

FIG. 8 is a flowchart of another example process in a control plane node according to some embodiments of the present disclosure;

FIG. 9 is a flowchart of an example process in a user plane node according to some embodiments of the present disclosure;

FIG. 10 is a flowchart of another example process in a user plane node according to some embodiments of the present disclosure; and

FIG. 11 is a signaling diagram of an example process according to some embodiments of the present disclosure.

### DETAILED DESCRIPTION

As described above, existing mechanisms for pausing/resuming of charging relying on URR level indications and/or occur per URR, which may have several disadvantages. One or more embodiments described herein, enhance the existing mechanism to inactivate/re-activate the usage measurement by introducing such control for a given PFCP session, and not per URR.

Before describing in detail exemplary embodiments, it is noted that the embodiments reside primarily in combinations of apparatus components and processing steps related to activating or deactivating pause of charging using at least one indication at the message level of PCFP level or in a PFCP request as opposed to at a URR level. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof. In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

In some embodiments, one of A and B corresponds to A or B. In some embodiments, at least one of A and B corresponds to A, B or AB, or to one or more of A and B. In some embodiments, at least one of A, B and C corresponds to one or more of A, B and C.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IOT) device, or a Narrowband IoT (NB-IOT) device, etc.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

Transmitting in downlink may pertain to transmission from the network or network node to the wireless device. Transmitting in uplink may pertain to transmission from the wireless device to the network or network node. Transmitting in sidelink may pertain to (direct) transmission from one wireless device to another. Uplink, downlink and sidelink (e.g., sidelink transmission and reception) may be considered communication directions. In some variants, uplink and downlink may also be used to described wireless communication between network nodes, e.g. for wireless backhaul and/or relay communication and/or (wireless) network communication for example between base stations or similar network nodes, in particular communication terminating at such. It may be considered that backhaul and/or relay communication and/or network communication is implemented as a form of sidelink or uplink communication or similar thereto.

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

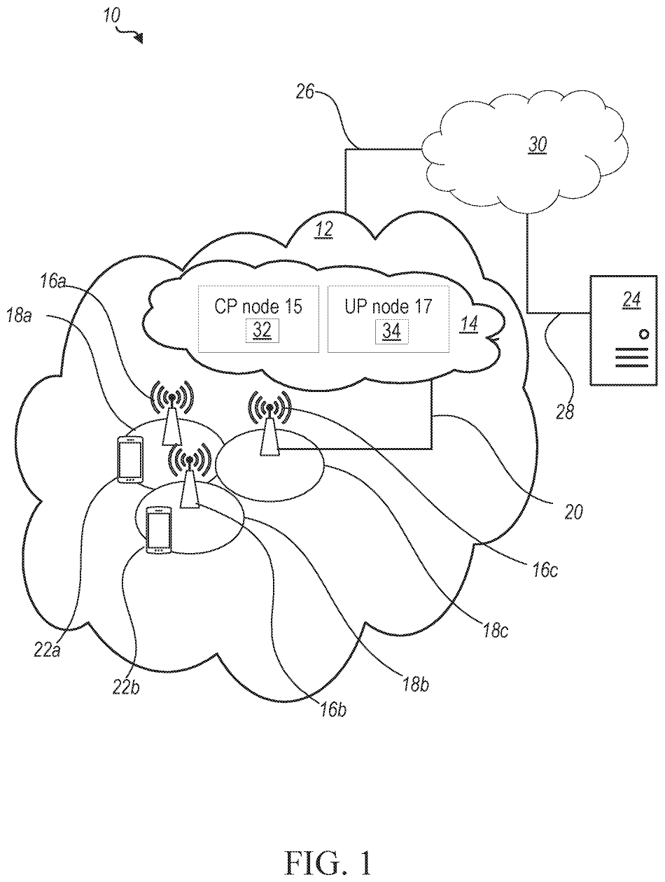

Some embodiments provide activating or deactivating pause of charging using at least one indication at the message level of PCFP level. Referring again to the drawing figures, in which like elements are referred to by like reference numerals, there is shown in FIG. 1 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. The core network 14 may include one or more logical nodes such as one or more control plane nodes 15 (referred to collectively as control plane node 15) and one or more user plane nodes 17 (referred to collectively as user plane node 17). In one or more embodiments, a control plane node 15 may correspond to one or more of SMF and PGW-C, among other control plane logical nodes. In one or more embodiments, a user plane node 17 may correspond to one or more of UPF and PGW-U, among other user plane logical nodes.

A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 can be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WD 22 can be in communication with an eNB for LTE/E-UTRAN and a gNB for NR/NG-RAN. WD22 may be configured to communicate with core network 14 via network node 16.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 1 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A control plane node 15 is configured to include a control unit 32 which is configured to perform one or more control plane node 15 functions as described herein such as with respect to activating or deactivating pause of charging using at least one indication at the message level of PCFP level. A user plane node 17 is configured to include a usage unit 34 which is configured to perform one or more user plane node 17 functions as described herein such as with respect to activating or deactivating pause of charging using at least one indication at the message level of PCFP level.

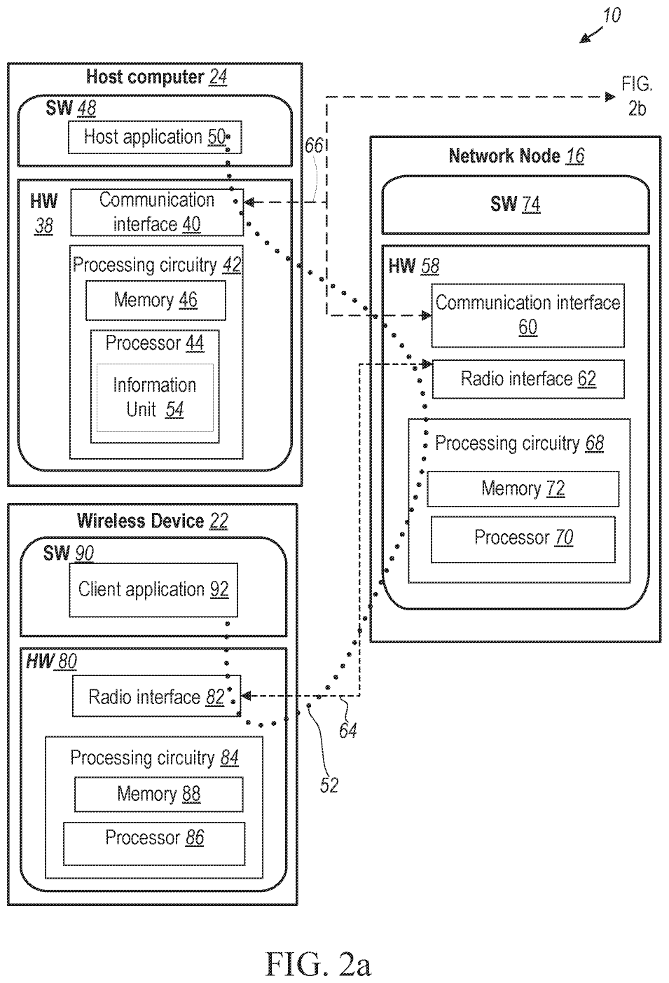

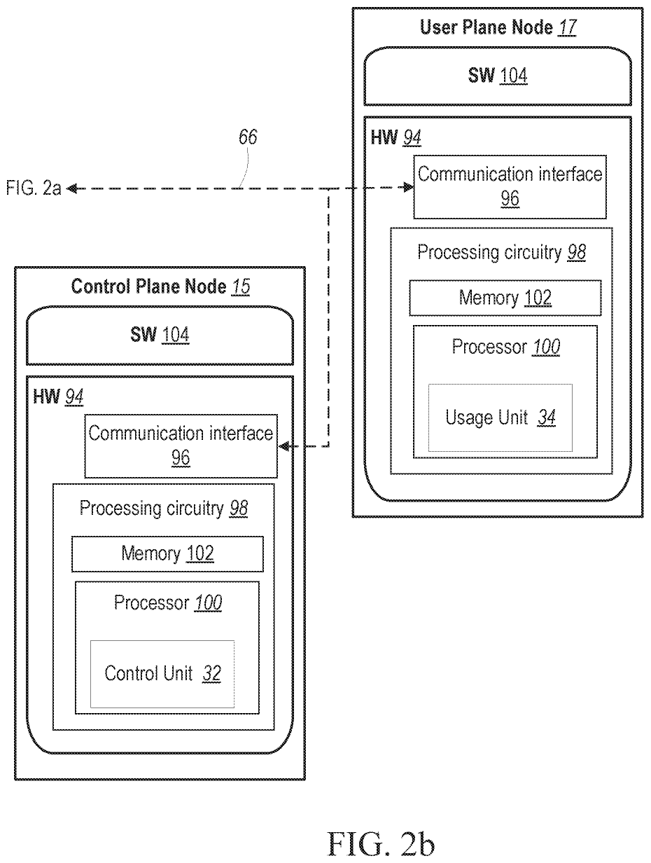

Example implementations, in accordance with an embodiment, of the WD 22, network node 16, control plane node 15, user plane node 17 and host computer 24 discussed in the preceding paragraphs will now be described with reference to FIGS. 2a-2b. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and/or the wireless device 22 and/or control plane node 15 and/or user plane node 17. The processing circuitry 42 of the host computer 24 may include an information unit 54 configured to enable the service provider to determine, store, relay, forward, transmit, receive, signal, analyze, initiate, etc., information related to activating or deactivating pause of charging using at least one indication at the message level of PCFP level. In some embodiments, “activating or deactivating pause of charging” is performed by pause/resume of usage measurements that is configured to pause/resume charging.

The communication system 10 further includes a network node 16 provided in a communication system 10 and including hardware 58 enabling it to communicate with the host computer 24, control plane node 15, user plane node 17 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to one or more of host computer 24, control plane node 15 and user plane node 17. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22.

The communication system 10 further includes a control plane node 15 provided in core network 14 and including hardware 94 enabling it to communicate with the host computer 24, user plane node 17, network node 16 and wireless device 22 (via network node 16). The hardware 58 may include a communication interface 96 for setting up and maintaining a wired or wireless connection with an interface of a different communication device of the communication system 10. The communication interface 60 may be configured to facilitate a connection 66 to one or more of host computer 24, network node 16 and user plane node 17.

In the embodiment shown, the hardware 94 of the control plane node 15 further includes processing circuitry 98. The processing circuitry 98 may include a processor 100 and a memory 102. In particular, in addition to or instead of a processor, such as a central processing unit, and memory, the processing circuitry 98 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 100 may be configured to access (e.g., write to and/or read from) the memory 102, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the control plane node 15 further has software 104 stored internally in, for example, memory 102, or stored in external memory (e.g., database, storage array, network storage device, etc.) accessible by the control plane node 15 via an external connection. The software 104 may be executable by the processing circuitry 98. The processing circuitry 98 may be configured to control any of the methods and/or processes described herein and/or to cause such methods, and/or processes to be performed, e.g., by control plane node 15. Processor 100 corresponds to one or more processors 100 for performing control plane node 15 functions described herein. The memory 102 is configured to store data, programmatic software code and/or other information described herein. In some embodiments, the software 104 may include instructions that, when executed by the processor 100 and/or processing circuitry 98, causes the processor 100 and/or processing circuitry 98 to perform the processes described herein with respect to control plane node 15. For example, processing circuitry 98 of the control plane node 15 may include control unit 32 which is configured to perform one or more control plane node 15 functions as described herein such as with respect to activating or deactivating pause of charging using at least one indication at the message level of PCFP level.

The communication system 10 further includes a user plane node 17 provided in core network 14. The user plane node 17 include the same hardware and software described with respect to control plane node 15 except that user plane node 17 is configured to perform different functions as described herein. For example, processing circuitry 98 of the user plane node 17 may include usage unit 34 which is configured to perform one or more user plane nodes 17 functions as described herein such as with respect to activating or deactivating pause of charging using at least one indication at the message level of PCFP level.

In some embodiments, the inner workings of the network node 16, WD 22, control plane node 15, user plane node 17 and host computer 24 may be as shown in FIGS. 2a-b and independently, the surrounding network topology may be that of FIG. 1.

In FIGS. 2a-b, the OTT connection 52 has been drawn abstractly to illustrate the communication between the host computer 24 and the wireless device 22 via the network node 16 (and/or control plane node 15 and/or user plane node 17, which connection is not shown), without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors, etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for

preparing/initiating/maintaining/supporting/ending a transmission to the network node 16, and/or preparing/terminating/maintaining/supporting/ending in receipt of a transmission from the network node 16.

Although FIGS. 1, 2a and 2b show various “units” such as control unit 32, and usage unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry.

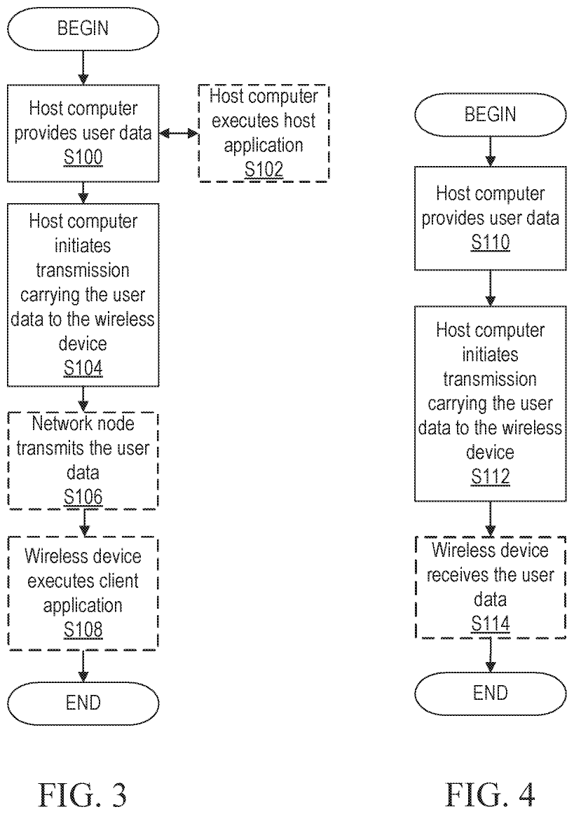

FIG. 3 is a flowchart illustrating an example method implemented in a communication system, such as, for example, the communication system of FIGS. 1, 2a and 2b, in accordance with one embodiment. The communication system may include a host computer 24, a network node 16 and a WD 22, which may be those described with reference to FIGS. 2a and 2b. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

FIG. 4 is a flowchart illustrating an example method implemented in a communication system, such as, for example, the communication system of FIG. 1, in accordance with one embodiment. The communication system may include a host computer 24, a network node 16, control plane node 15, user plane node 17 and a WD 22, which may be those described with reference to FIGS. 1, 2a and 2b. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

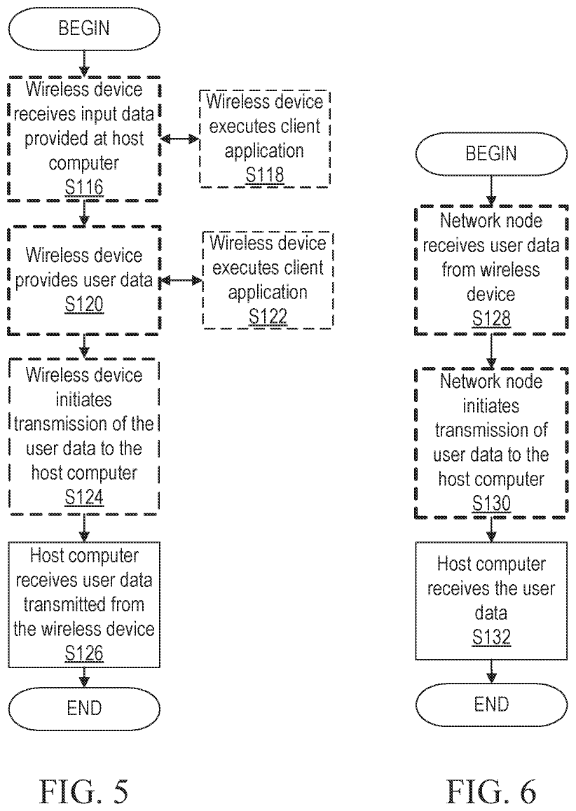

FIG. 5 is a flowchart illustrating an example method implemented in a communication system, such as, for example, the communication system of FIG. 1, in accordance with one embodiment. The communication system may include a host computer 24, a network node 16, control plane node 15, user plane node 17 and a WD 22, which may be those described with reference to FIGS. 1, 2a and 2b. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 6 is a flowchart illustrating an example method implemented in a communication system, such as, for example, the communication system of FIG. 1, in accordance with one embodiment. The communication system may include a host computer 24, a network node 16, control plane node 15, user plane node 17 and a WD 22, which may be those described with reference to FIGS. 1, 2a and 2b. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

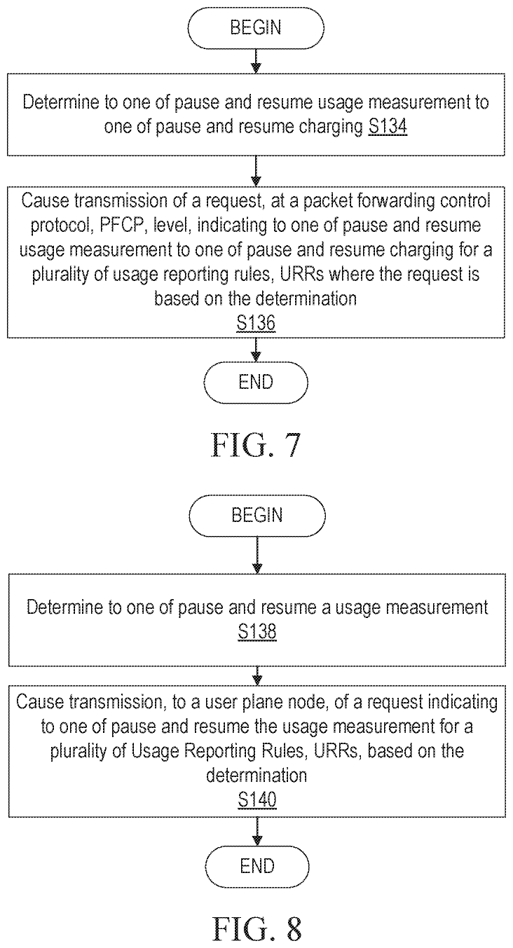

FIG. 7 is a flowchart of an example process in a control plane node 15 according to some embodiments of the present disclosure. One or more blocks described herein may be performed by one or more elements of control plane node 15 such as by one or more of processing circuitry 98 (including the control unit 32), processor 100, and/or communication interface 96. Control plane node 15 is configured to determine (Block S134) to one of pause and resume usage measurement to one of pause and resume charging, as described herein. Control plane node 15 is configured to cause (Block S136) transmission of a request, at a packet forwarding control protocol, PFCP, level, indicating to one of pause and resume usage measurement to one of pause and resume charging for a plurality of usage reporting rules, URRs where the request is based on the determination, as described herein.

According to one or mor embodiments, the indication to pause usage measurement to pause is provided by a first flag set to a predefined value while a ASPOC flag is set to 1. According to one or mor embodiments, the indication to resume usage measurement to resume charging is provided by a second flag set to a predefined value while a ASPOC flag is set to 1. According to one or mor embodiments, the predefined value is 1.

FIG. 8 is a flowchart of another example process in a control plane node 15 according to some embodiments of the present disclosure. One or more blocks described herein may be performed by one or more elements of control plane node 15 such as by one or more of processing circuitry 98 (including the control unit 32), processor 100, and/or communication interface 96. Control plane node 15 is configured to determine (Block S138) to one of pause and resume a usage measurement, as described herein. Control plane node 15 is configured to cause (Block S140) transmission, to a user plane node, of a request indicating to one of pause and resume the usage measurement for a plurality of Usage Reporting Rules, URRs, based on the determination.

According to one or more embodiments, the indication to pause the usage measurement for the plurality of URRs, for which value of an Applicable for Start of Pause of Charging, ASPOC, flag is set to a “1” bit value, is provided by a first flag set to a predefined bit value. According to one or more embodiments, the predefined bit value for the first flag is a “1” bit value. According to one or more embodiments, the first flag is a Stop of Usage Measurement to Pause Charging, SUMPC, flag.

According to one or more embodiments, the indication to resume the usage measurement for the plurality of URRs, for which value of an Applicable for Start of Pause of Charging, ASPOC, flag is set to a “1” bit value, is provided by a second flag set to a predefined bit value. According to one or more embodiments, the predefined bit value for the second flag is a “1” bit value. According to one or more embodiments, the second flag is a Resume of Usage Measurement to Un-pause of Charging, RUMPC, flag. In particular, SUMPC/RUMPC may corresponds to flags/bits that are sent in the PFCPSMReq-Flags IE in PFCP session modification requests by the CP function to request that the UP function stop or resume usage measurements due to pause of charging on the URRs marked with the ASPOC bit/flag.

According to one or more embodiments, the indication is on a message level in the request. According to one or more embodiments, the control plane node is a Session Management Function, SMF, node or Packet Gateway Control function, PGW-C, node. According to one or more embodiments, the control plane node provides a session management functions.

According to one or more embodiments, the user plane node is a User Plane Function, UPF, node or Packet Gateway User function, PGW-U, node. According to one or more embodiments, the request is one of a Packet Forwarding Control Protocol, PFCP, session establishment request and PFCP session modification request associated with a PFCP session, the PFCP session being associated with the plurality of URRs.

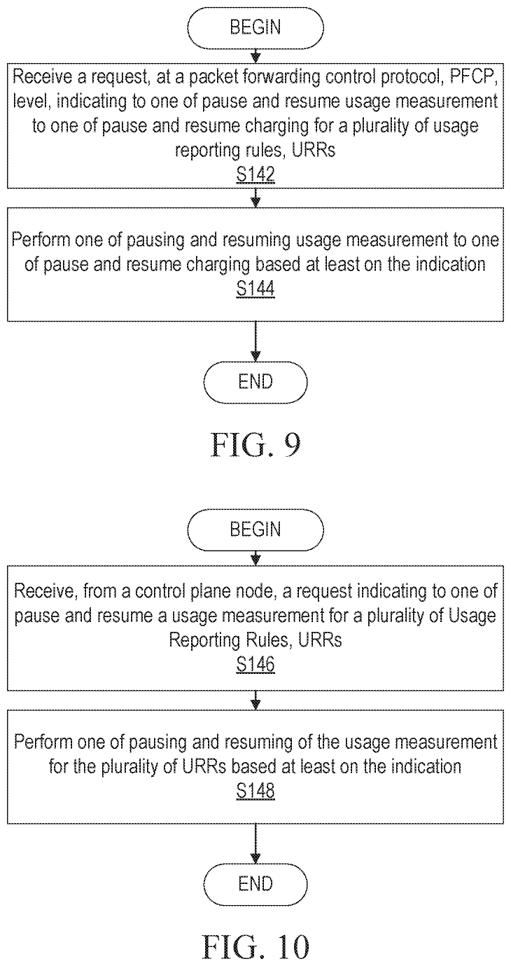

FIG. 9 is a flowchart of an example process in a user plane node 17 according to some embodiments of the present disclosure. One or more blocks described herein may be performed by one or more elements of user plane node 17 such as by one or more of processing circuitry 98 (including the control unit 32), processor 100, and/or communication interface 96. User plane node 17 is configured to receive (Block S142) a request, at a packet forwarding control protocol, PFCP, level, indicating to one of pause and resume usage measurement to pause and resume charging for a plurality of usage reporting rules, URRs, as described herein. User plane node 17 is configured to perform (Block S144) one of pausing and resuming usage measurement to one of pause and resume charging based at least on the indication, as described herein.

According to one or more embodiments, the indication to pause charging for usage measurement is provided by a first flag set to a predefined value while a ASPOC flag is set to 1. According to one or more embodiments, the indication to resume usage measurement to resume charging is provided by a second flag set to a predefined value while a ASPOC flag is set to 1. According to one or more embodiments, the predefined value is 1.

FIG. 10 is a flowchart of another example process in a user plane node 17 according to some embodiments of the present disclosure. One or more blocks described herein may be performed by one or more elements of user plane node 17 such as by one or more of processing circuitry 98 (including the control unit 32), processor 100, and/or communication interface 96. User plane node 17 is configured to receive (Block S146), from a control plane node, a request indicating to one of pause and resume a usage measurement for a plurality of Usage Reporting Rules, URRs, as described herein. The user plane node 17 is configured to perform (Block S148) one of pausing and resuming of the usage measurement for the plurality of URRs based at least on the indication, as described herein.

According to one or more embodiments, the indication to pause the usage measurement for the plurality of URRs, for which value of an Applicable for Start of Pause of Charging, ASPOC, flag is set to a “1” bit value, is provided by a first flag set to a predefined bit value. According to one or more embodiments, the predefined bit value for the first flag is a “1” bit value. According to one or more embodiments, the first flag is a Stop of Usage Measurement to Pause Charging, SUMPC, flag.

According to one or more embodiments, the indication to resume the usage measurement for the plurality of URRs, for which value of an Applicable for Start of Pause of Charging, ASPOC, flag is set to a “1” bit value, is provided by a second flag set to a predefined bit value. According to one or more embodiments, the predefined bit value for the second flag is a “1” bit value. According to one or more embodiments, the second flag is a Resume of Usage Measurement to Un-pause of Charging, RUMPC, flag.

According to one or more embodiments, the indication is on a message level in the request. According to one or more embodiments, the user plane node is a User Plane Function, UPF, node or Packet Gateway User function, PGW-U, node. According to one or more embodiments, the control plane node is a Session Management Function, SMF, node or Packet Gateway Control function, PGW-C, node. According to one or more embodiments, the request is one of a Packet Forwarding Control Protocol, PFCP, session establishment request and PFCP session modification request associated with a PFCP session, the PFCP session being associated with the plurality of URRs.

Having generally described arrangements for activating or deactivating pause of charging (i.e., activating or deactivating usage measurements to activate or deactivate charging) using at least one indication at the message level of PCFP level, details for these arrangements, functions and processes are provided as follows, and which may be implemented by the control plane node 15, user plane node 17 and/or host computer 24.

Some embodiments provide activating or deactivating pause of charging using at least one indication at the message level of PCFP level. In some embodiments, “activating or deactivating pause of charging” is performed by pause/resume of usage measurements that is configured to pause/resume charging.

One or more control plane node 15 functions described below may be performed by one or more of processing circuitry 98, processor 100, communication interface 96, control unit 32, etc., of control plane node 15. One or more user plane node 17 functions described below may be performed by one or more of processing circuitry 98, processor 100, communication interface 96, usage unit 34, etc., of user plane node 17.

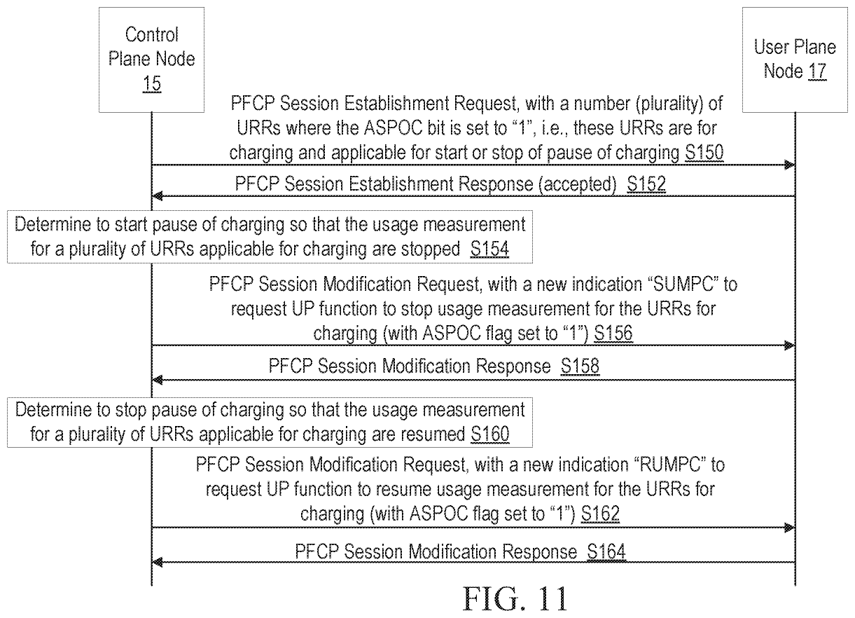

FIG. 11 is an example signaling diagram according to one or more embodiments of the present disclosure. Control plane node 15 is configured to cause (Block S150) transmission of a PFCP session establishment request, with a number (plurality) of URRs, where the ASPOC bit is set to “1”, i.e., these URR are for charging and applicable for start or stop of Pause of charging (i.e., to start or stop usage measurements to start or stop charging) as described herein. User plane node 17 is configured to cause (Block S152) transmission of PFCP session establishment response (accepted), as described herein. Control plane node 15 is configured to determine (Block S154) to start pause of charging so that usage measurement for those URRs applicable for charging are stopped, i.e., to start pause of usage measurements to pause charging for those URRs applicable for charging are stopped, as described herein.

Control plane node 15 is configured to cause (Block S156) transmission of a PFCP session modification request with the indication “SUMPC” to request UP function to stop usage measurement for the URRs for charging (with ASPOC flag set to “1”), as described herein. User plane node 17 is configured to cause (Block S158) transmission of a PFCP session modification response, as described herein. Control plane node 15 is configured to determine (Block S160) to stop pause of charging so that usage measurement for those URRs applicable for charging is resumed, as described herein. Control plane node 15 is configured to cause (Block S162) transmission of a PFCP session modification request with indication “RUMPC” to request UP function to resume usage measurement for the URR for charging (with ASPOC flag set to “1”), as described herein. In one or more embodiments, the UP function resumes the usage measurement for all URRs with the ASPOC flag is set to “1” regardless if the usage measurement was stopped at being requested by the CP function using SUMPC flag or using Inactive Measurement flag per URR, or being notified by the downstream GTP-U entity using Tunnel Status message. User plane node 17 is configured to cause (Block S164) transmission of a PFCP session modification response, as described herein.

Therefore, one or more embodiments described herein solve one or more issues identified in the clause 2 of 3GPP standards such as in, for example, 3GPP TS 29.244, in addition, it provides a useful enhancement to activate/deactivate Pause of Charging using the indication provisioned at the message level, instead of per Usage Report level.

### EXAMPLES

Example A1. A control plane node 15 configured to, and/or comprising a communication interface 96 and/or comprising processing circuitry 98 configured to:

determine to one of pause and resume a usage measurement to one of pause and resume charging; and

cause transmission of a request, at a packet forwarding control protocol, PFCP, level, indicating to one of pause and resume the usage measurement to one of pause and resume charging for a plurality of usage reporting rules, URRs, based on the determination.

Example A2. The control plane node 15 of Example A1, wherein the indication to pause the usage measurement to pause the charging is provided by a first flag set to a predefined value while a ASPOC flag is set to 1.

Example A3. The control plane node 15 of Example A1, wherein the indication to resume the usage measurement to resume is provided by a second flag set to a predefined value while a ASPOC flag is set to 1.

Example A4. The control plane node 15 of any one of Examples A2-A3, wherein the predefined value is 1.

Example B1. A method implemented in a control plane node 15, the method comprising:

determining to one of pause and resume a usage measurement to one of pause and resume charging for usage measurement; and

causing transmission of a request, at a packet forwarding control protocol, PFCP, level, indicating to one of pause and resume a usage measurement to one of pause and resume charging for a plurality of usage reporting rules, URRs, based on the determination.

Example B2. The method of Example B1, wherein the indication to pause the usage measurement to pause charging is provided by a first flag set to a predefined value while a ASPOC flag is set to 1.

Example B3. The method of Example B1, wherein the indication to resume the usage measurement to resume charging is provided by a second flag set to a predefined value while a ASPOC flag is set to 1.

Example B4. The method of any one of Examples B2-B3, wherein the predefined value is 1.

Example C1. A user plane node 17 configured to, and/or comprising a communication interface 96 and/or comprising processing circuitry 98 configured to:

receive a request, at a packet forwarding control protocol, PFCP, level, indicating to one of pause and resume a usage measurement to one of pause and resume charging for a plurality of usage reporting rules, URRs; and

perform one of pausing and resuming of the usage measurement to one of pause and resume charging based at least on the indication.

Example C2. The user plane node 17 of Example C1, wherein the indication to pause the usage measurement to pause charging is provided by a first flag set to a predefined value while a ASPOC flag is set to 1.

Example C3. The user plane node 17 of Example C1, wherein the indication to resume the usage measurement to resume charging is provided by a second flag set to a predefined value while a ASPOC flag is set to 1.

Example C4. The user plane node 17 of any one of Examples C2-C3, wherein the predefined value is 1.

Example D1. A method implemented in a user plane node 17, the method comprising:

receiving a request, at a packet forwarding control protocol, PFCP, level, indicating to one of pause and resume usage measurements to one of pause and resume charging for a plurality of usage reporting rules, URRs; and

performing one of pausing and resuming usage measurements to one of pause and resume charging for usage measurement based at least on the indication.

Example D2. The method of Example D1, wherein the indication to pause usage measurements to pause charging is provided by a first flag set to a predefined value while a ASPOC flag is set to 1.

Example D3. The method of Example D1, wherein the indication to resume usage measurements to resume charging is provided by a second flag set to a predefined value while a ASPOC flag is set to 1.

Example D4. The method of any one of Examples D2-D3, wherein the predefined value is 1.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A control plane node comprising:
processing circuitry configured to:
determine to one of pause and resume a usage measurement; and
cause transmission, to a user plane node, of a request indicating to one of pause and resume the usage measurement for a plurality of Usage Reporting Rules, URRs, based on the determination.

2. The control plane node of claim 1, wherein the indication to pause the usage measurement for the plurality of URRs, for which value of an Applicable for Start of Pause of Charging, ASPOC, flag is set to a “1” bit value, is provided by a first flag set to a predefined bit value.

3. (canceled)

4. (canceled)

5. The control plane node of claim 1, wherein the indication to resume the usage measurement for the plurality of URRs, for which value of an Applicable for Start of Pause of Charging, ASPOC, flag is set to a “1” bit value, is provided by a second flag set to a predefined bit value.

6. (canceled)

7. (canceled)

8. The control plane node of claim 1, wherein the indication is on a message level in the request.

9-12. (canceled)

13. A method implemented by a control plane node, the method comprising:
determining to one of pause and resume a usage measurement; and
causing transmission, to a user plane node, of a request indicating to one of pause and resume the usage measurement for a plurality of Usage Reporting Rules, URRs, based on the determination.

14. The method of claim 13, wherein the indication to pause the usage measurement for the plurality of URRs, for which value of an Applicable for Start of Pause of Charging, ASPOC, flag is set to a “1” bit value, is provided by a first flag set to a predefined bit value.

15. (canceled)

16. (canceled)

17. The method of claim 13, wherein the indication to resume the usage measurement for the plurality of URRs, for which value of an Applicable for Start of Pause of Charging, ASPOC, flag is set to a “1” bit value, is provided by a second flag set to a predefined bit value.

18. The method of claim 17, wherein the predefined bit value for the second flag is a “1” bit value.

19. The method of claim 17, wherein the second flag is a Resume of Usage Measurement to Un-pause of Charging, RUMPC, flag.

20. The method of claim 13, wherein the indication is on a message level in the request.

21-24. (canceled)

25. A user plane node comprising:
processing circuitry configured to:
receive, from a control plane node, a request indicating to one of pause and resume a usage measurement for a plurality of Usage Reporting Rules, URRs; and
perform one of pausing and resuming of the usage measurement for the plurality of URRs based at least on the indication.

26. The user plane node of claim 25, wherein the indication to pause the usage measurement for the plurality of URRs, for which value of an Applicable for Start of Pause of Charging, ASPOC, flag is set to a “1” bit value, is provided by a first flag set to a predefined bit value.

27. (canceled)

28. (canceled)

29. The user plane node of claim 25, wherein the indication to resume the usage measurement for the plurality of URRs, for which value of an Applicable for Start of Pause of Charging, ASPOC, flag is set to a “1” bit value, is provided by a second flag set to a predefined bit value.

30. The user plane node of claim 29, wherein the predefined bit value for the second flag is a “1” bit value.

31. The user plane node of claim 29, wherein the second flag is a Resume of Usage Measurement to Un-pause of Charging, RUMPC, flag.

32. The user plane node of claim 25, wherein the indication is on a message level in the request.

33. The user plane node of claim 25, wherein the user plane node is a User Plane Function, UPF, node or Packet Gateway User function, PGW-U, node.

34. The user plane node of claim 25, wherein the control plane node is a Session Management Function, SMF, node or Packet Gateway Control function, PGW-C, node.

35. The user plane node of claim 25, wherein the request is one of a Packet Forwarding Control Protocol, PFCP, session establishment request and PFCP session modification request associated with a PFCP session, the PFCP session being associated with the plurality of URRs.

36-48. (canceled)
